(19) United States
(12) Patent Application Publication
(10) Pub. No.: US 2004/0242192 A1
(43) Pub. Date: Dec. 2, 2004

(54) Telecommunication terminal for an ad hoc network having means enabling a user to limit the resources utilized by the network

(75) Inventors: Olivier Marce, Massy (FR); Herve Maillard, Igny (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/671,580

(22) Filed: Sep. 29, 2003

(30) Foreign Application Priority Data
Sep. 30, 2002 (FR) 02 12 057

(51) Int. Cl. H04M 15/00; H04M 11/00

(52) U.S. Cl. 455/405; 379/114.01

(57) ABSTRACT

A telecommunication terminal receives data addressed to a destination telecommunication terminal and including information on the destination telecommunication terminal which is used to calculate a next terminal as a function of the information and to send the data to the next terminal. The terminal determines at least one threshold limiting use of the resources of the terminal by the routing means.

### CROSS-REFERENCE TO RELATED APPLICATIONS

This application is based on French Patent Application No. 02 12 057 filed Sep. 30, 2002, the disclosure of which is hereby incorporated by reference thereto in its entirety, and the priority of which is hereby claimed under 35 U.S.C. §119.

### BACKGROUND OF THE INVENTION

1. Field of the Invention

The field of the invention is that of telecommunication networks. The invention applies more particularly to mobile telecommunication networks in which the resources of the mobile terminals are used by the network to route data.

A network of this kind is known as an ad hoc network.

2. Description of the Prior Art

FIGS. 1a and 1b show an ad hoc network N. The network includes a set of terminals A, B, C, D. These are typically, although not exclusively, mobile terminals having radio transmission capabilities. The terminals also have a data routing (relay) function: in the FIG. 1a example, the data sent by terminal A to terminal B can be routed via terminals B and C if the technology does not enable direct transmission between terminals A and D (because the distance between them is too great, for example).

Because the terminals are mobile, the routing rules must constantly adapt to their relative positions. Thus in FIG. 1b, terminal D has moved closer to terminal B and terminal C has moved farther away from it. Terminal B must take account of this and send the data directly to terminal D.

Clearly routing data by means of successive relays consumes resources of each mobile terminal involved in the routing process. The resources referred to are of different kinds, including in particular memory resources and energy resources. Each relayed message consumes energy in the terminal relaying the message and storing routing information to another terminal necessitates the use of a portion of the memory of the relay terminal.

From the point of view of the terminal user, these uses of resources can lead to various problems:

When he is using his telecommunication terminal, routing data of other users and managing routes between terminals can degrade the performance of his own terminal. For example, access to some functions may be slowed down or even prevented.

Whether he is using his terminal or not, routing data and managing routes cause excess consumption of memory resources and energy, i.e. reduced standby time. Thus, even if he does not use his telecommunication terminal, the user may be surprised that it is impossible to use some or all of these functions because its energy capacities (batteries) have been discharged or because of congestion (saturation) of its memory.

One solution is for the user to switch off his telecommunication terminal when he is not using it, or if he is unable to recharge it easily if it becomes discharged (for example because he is traveling).

However, from the network point of view, this kind of solution is not acceptable because it deprives the network of the routing capacities of the telecommunication terminal that is switched off. If a sufficiently large number of users do the same, the network may no longer be functional, and its performance will be degraded in any event.

Moreover, from the point of view of the user, this kind of solution has the major drawback that he cannot be called.

Another existing solution consists in making the choice of a transmission route dependent on the remaining resources in the communication terminal (generally the state of charge of the batteries). This is effected by a route determination protocol. A solution of this kind is described in the paper “Power-aware Routing in Mobile Ad Hoc Networks” by Suresh Singh and Mike Woo, delivered at the 1998 “Mobile Computing and Networking” conference, for example.

However, this solution does not solve the problem from the user's point of view. It enables the network to optimize its operation as a function of the resources in the available terminals, but does not allow the user to indicate how he wishes his resources to be used.

Another solution is disclosed in the patent application WO 03021817 and consists in allowing the user of a terminal to signal that his terminal is not available for routing. This solution is binary, however. It therefore suffers from some of the drawbacks of the solution consisting in switching off the terminal, through the possibility of a shortfall of routing resources for the network. It is therefore clearly inadequate.

The object of the present invention is to alleviate the drawbacks caused by the use of resources of the user terminal by the services of the telecommunication network without the control of the user, but without calling into question the functioning of the network.

### SUMMARY OF THE INVENTION

The invention firstly consists in a telecommunication terminal including routing means for receiving data addressed to a destination telecommunication terminal, the data including information on the destination telecommunication terminal, which is used to calculate a next telecommunication terminal as a function of the information and to send the data to the next telecommunication terminal, which telecommunication terminal is characterized in that it also includes means for determining at least one threshold limiting use of the resources of the telecommunication terminal by the routing means.

In a preferred embodiment, the operation of the routing means depends on comparing the resources and the at least one threshold.

The resources can be energy resources, memory resources, etc.

In one embodiment, the telecommunication terminal further includes means for determining that a message is an emergency message and within which the limitation on resources is ineffective for emergency messages.

In one embodiment, the value of the threshold is transmitted to a billing center applying a policy whereby billing is dependent on the value of the threshold.

The routing means can also be unavailable for messages originating from the telecommunication terminal if the account of the user of the telecommunication terminal with the billing center is below a second threshold that is preferably equal to 0.

In one embodiment, the routing means can also be adapted to determine the next telecommunication terminal as a function of comparing the threshold and the resources for the telecommunication terminals concerned.

The invention secondly consists in a billing center for establishing an invoice associated with users of a telecommunication network as a function of a billing policy and the use of the telecommunication network by the users, characterized in that the billing policy consists in:

crediting a user with the charge associated with the threshold value reached during the transmission of messages for other users, and

debiting a user with the threshold value reached during the transmission of his own calls by the other users.

In one embodiment, the billing center further includes means for associating a charge with a threshold value.

The user can fix for himself the charge associated with a threshold value.

The invention will emerge more clearly from the following description of one embodiment of the invention, which is given with reference to the appended drawings.

### BRIEF DESCRIPTION OF THE DRAWINGS

FIGS. 1a and 1b, already commented on, show an ad hoc network and how it evolves over time.

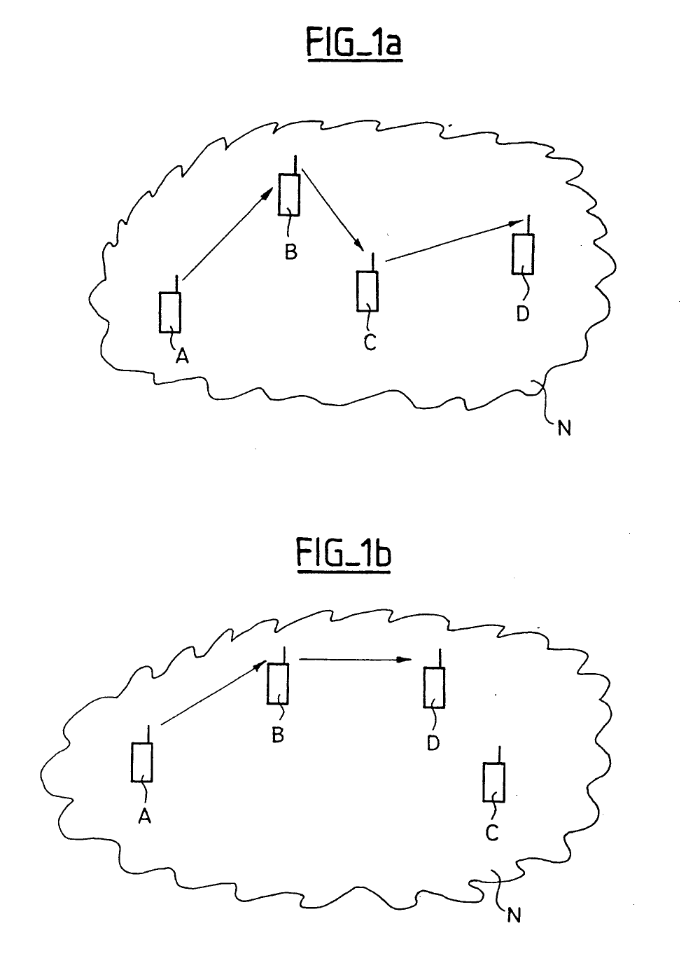

FIGS. 2a and 2b show two embodiments of a telecommunication terminal according to the invention.

### DETAILED DESCRIPTION OF THE PREFERRED EMBODIMENTS

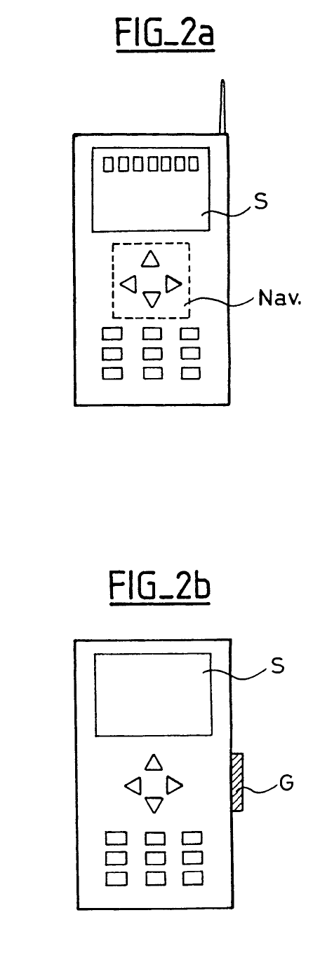

FIGS. 2a and 2b show two embodiments of the man-machine interface (MMI) of a mobile telecommunication terminal.

FIG. 2a shows a conventional embodiment in which the threshold can be determined by means of configuration menus of the mobile terminal. The user can access the threshold setting facility by browsing through configuration menus in the conventional way, and adjust the threshold using the navigator key Nav of his terminal. In FIG. 2a, the setting is shown in the form of a bar in which the number of shaded boxes represents the threshold level, but clearly any form of a graphical representation is possible.

FIG. 2b shows another option, whereby the facility for adjusting the threshold is accessible to the user directly, without using the configuration menus, by way of control means G, which can be a slider for selecting a threshold between two extreme end values.

In either embodiment, the mobile terminal user can determine one or more thresholds. A threshold can be selected continuously, between two extreme values, or from a set of predefined values. Thus three values may be predefined: 25%, 50%, and 75%, for example.

The extreme values can provide for the reservation of minimum resources for the routing means of the mobile terminal. For example, there can be provision for the user not to be able to specify a resources reservation threshold of greater than 90% or 95% of his available resources, in order to ensure a minimum quality of service within the ad hoc network (whether these are energy resources, memory resources or any other kind of resource).

Conversely, there can be provision for the threshold not to be less than 5% or 10% so that the transmission (relaying) of data does not block other functions of the mobile terminal and the user can have the benefit of a minimum quality of service whenever possible.

In concrete terms, this can also mean that the last 5% of the energy resources are reserved for the user of the mobile terminal, for example.

In one embodiment of the invention, the operation of the routing means depends on comparing the resources and the threshold(s).

In particular, if only one threshold has been defined, the routing means can be functional only if the resources exceed that threshold, as determined by the user.

This may refer to energy resources, in which case the routing means are functional only if the energy resource level (for example the level of charge of the battery contained in the mobile terminal) is above the threshold.

It may also refer to memory resources, in which case the routing means are functional only if the quantity of memory still available is above the threshold.

If the routing means are not functional, the terminal can be obliged:

either no longer to respond to any solicitation from the network, except for those that correspond to setting up a call addressed to it,

or report to the network that it is in standby mode, and can no longer relay calls. Depending on the protocol employed in the network, the terminal may be able to indicate that it is able to receive only calls addressed to it.

In one embodiment, if the routing means are not functional, the terminal nevertheless transmits emergency calls, which can be identified by marking the packets constituting them.

This is different from the function already used in radio communication terminals (energy saving mode), in that it relates to the momentary interruption of the call relay function of the terminal, and not of all calls.

For example, the invention can be implemented in a terminal using the Dynamic Source Routing (DSR) ad hoc routing protocol, in the following manner, although this is not limiting on the invention.

If the resources of the terminal fall below the threshold defined by the user, the following modifications of the DSR protocol apply:

Modification 1: The terminal silently eliminates “Route Request” and “Route Response” messages in order no longer to appear as a relay in the eyes of the other terminals. If the terminal receives a “Route Request” message addressed to it, or where applicable that corresponds to an emergency call, it continues to behave normally. Thus the node can be contacted and can continue to provide the support necessary for emergency calls.

Modification 2: If the terminal is solicited as a relay for relaying a packet, it does not transmit it and sends back a “Route Error” message so that paths in which the terminal appears as a relay are eliminated from the routing tables of the other terminals. As previously mentioned, an exception can be made for messages corresponding to emergency calls.

In one embodiment of the invention, where the user defines a plurality of thresholds, the terminal can apply modification 1 when a first threshold is reached and modifications 1 and 2 when a second threshold is reached, for example. In this way the terminal reduces its communication with the network, and therefore its consumption of resources, in a progressive manner.

In one embodiment of the invention, a charging policy is associated with the determination of the threshold by the user.

When its resources are used by the network, the terminal compares the available resources of the terminal with the thresholds defined by the user. The corresponding range of thresholds is associated with the call. The association is then sent to a billing center, either on-line (at the same time as the call) or off-line (in which case the terminal stores the information and sends it periodically, or at the request of the billing center).

The function of the billing center according to the invention is to draw up an invoice associated with the users of the telecommunication network. The invoice depends firstly on the use of the network by the users and secondly on a billing policy.

According to the invention, the billing center determines the threshold value reached and then consolidates the associations, crediting users whose terminals' resources have been used for calls of other users, and debiting users who have used the resources of the terminals of other users.

To this end, the billing center can be provided with association means (for example a basic correspondence table) associating charges with threshold values.

In one embodiment of the invention, the charges can be fixed by the user himself.

In one embodiment of the invention, the routing means can be unavailable for messages originating from the telecommunication terminal if the account of the user of the telecommunication terminal at the billing center is below a second threshold, which is preferably equal to 0. In other words, if the account of the user is negative or below the second threshold, he can no longer use his terminal to send messages; the routing means will therefore be available only for the relay function.

The second threshold can be different from 0, and either positive or negative (in which case “discovery” is authorized by the telecommunication network operator).

As previously mentioned, an exception can be made for emergency calls, which can always be routed.

In the above embodiments, information on the user's balance is sent at the same time as a request to use his resources.

Accordingly, if the user chooses to retain the resources for his own personal use, he can be invoiced additional amounts. On the other hand, if he decides to allow the network to use his resources, he can benefit from reduced charges or even negative charges, i.e. credits to his account.

Thus the user has to decide on a compromise between how much of the resources of his telecommunication terminal he agrees to make available to the community and the charge he wishes to pay. Through this compromise, the invention proposes a commercial model susceptible to allow the deployment of ad hoc telecommunication networks.

In one embodiment of the invention, in choosing a path to take, the routing protocols can take account of thresholds fixed by the users, and thus of the value that they associate with their resources. The choice of the next telecommunication terminal (i.e. that to which the data is finally transmitted), from the nearby terminals, is then made as a function comparing threshold and said resources.

This approach minimizes the number of telecommunication terminals that have reached the threshold and thus the number of telecommunication terminals whose routing means are no longer functional.

In the situation where a billing policy dependent on the threshold has been instituted, it statistically favors terminals having a low threshold, and thus for which billing is highest.

There is claimed:

1. A telecommunication terminal including routing means for receiving data addressed to a destination telecommunication terminal, said data including information on said destination telecommunication terminal, which is used to calculate a next telecommunication terminal as a function of said information and to send said data to said next telecommunication terminal, which telecommunication terminal is characterized in that it also includes means for determining at least one threshold limiting use of the resources of said telecommunication terminal by said routing means.

2. The telecommunication terminal claimed in claim 1, wherein the operation of said routing means depends on comparing said resources and said at least one threshold.

3. The telecommunication terminal claimed in claim 1, wherein said resources are energy resources.

4. The telecommunication terminal claimed in claim 1, wherein said resources are memory resources.

5. A telecommunication terminal according to claim 1, further including means for determining that a message is an emergency message and within which the limitation on resources is ineffective for emergency messages.

6. The telecommunication terminal claimed in claim 1, wherein the value of said threshold is transmitted to a billing center applying a policy whereby billing is dependent on the value of said threshold.

7. The telecommunication terminal claimed in claim 6, wherein said routing means are not available for messages originating from said telecommunication terminal if the account of the user of said telecommunication terminal with said billing center is below a second threshold that is preferably equal to 0.

8. The telecommunication terminal claimed in claim 1, wherein said routing means are adapted to determine said next telecommunication terminal as a function of comparing said threshold and said resources for the telecommunication terminals concerned.

9. A billing center for establishing an invoice associated with users of a telecommunication network as a function of a billing policy and the use of said telecommunication network by said users, characterized in that said billing policy consists in:
crediting a user with the charge associated with the threshold value reached during the transmission of messages for other users, and
debiting a user with the threshold value reached during the transmission of his own calls by the other users.

10. The billing center claimed in claim 9, further including means for associating a charge with a threshold value.

11. The billing center claimed in claim 10, wherein the user can fix for himself the charge associated with a threshold value.
